(19) United States
(12) Patent Application Publication
(10) Pub. No.: US 2024/0351567 A1
(43) Pub. Date: Oct. 24, 2024

(54) 4-D WAVE MAPPING NAVIGATION SYSTEM AND METHOD

(71) Applicant: Jacob BRANCATO, Montreal (CA)

(72) Inventor: Jacob BRANCATO, Montreal (CA)

(21) Appl. No.: 18/684,632

(22) PCT Filed: Aug. 17, 2022
(86) PCT No.: PCT/CA2022/051252

§ 371 Date: Feb. 16, 2024

Related U.S. Application Data
(60) Provisional application No. 63/234,195, filed on Aug. 17, 2021.

(51) Int. Cl. B60V 1/08

(52) U.S. Cl. CPC B60V 1/08

(57) ABSTRACT

A method for providing autonomous and semi-autonomous navigation of a vehicle over water, comprising the steps of: receiving data in the form of buoy water state data and vehicle sensor data, computing a mean wave and water height in a path of the vehicle, computing a mean theoretical water height from the buoy water state data and setting it as a base datum; generating 3D curves from the received data, converting the 3D curves into 2D planar point data, determining wave peaks from maximum amplitude point data of the 2D planar point data, generating 3D wave apex data from the wave peaks, predicting wave height peaks based on current buoy water state data, generating flight parameters using the received data, the 3D wave apex data and the predicted wave height peaks, generating vehicle flight control commands, and adjusting the flight control commands.

### CROSS-REFERENCE TO RELATED APPLICATIONS

This application claims the benefits of U.S. provisional patent application No. 63/234,195 filed on Aug. 17, 2021, which is herein incorporated by reference.

### TECHNICAL FIELD

The present disclosure relates to a 4-D wave mapping, navigation system and method using dynamic fluid height telemetry for autonomous or semi-autonomous multi-platform unmanned vehicles, and more particularly, unmanned Wing In Ground Effect (WIG) crafts or vessels.

### BACKGROUND

Overseas shipping is huge business. Enormous cargo ships continually traverse shipping lanes in international waterways, carrying large shipments of goods enclosed in containers the size of railroad cars to distant destinations that take days to reach. Each container can hold a portion of a much larger shipment, can contain a single smaller shipment, or include a collection of smaller shipments. Frequently, shipping an order that does not fill a container means the order may wait on the dock until other small orders to fill the container. Thus, it can easily take weeks from the shipping date for an order to arrive at its destination. Typically, someone shipping a small shipment may be unwilling to wait days or weeks. Also, some cargo, such as food or other perishables, may not survive an extended shipping time.

Alternately, airfreight is available for timely shipping smaller shipments. Typically, ground transport carries parcels to/from airports where a fleet of aircraft transport cargo between the airports. While international airfreight may be a reasonable solution for letters and even for small packages, the cost may be excessive for larger shipments, shipments that may be a relatively small portion of a shipping container. DHL, for example, applies a fixed surcharge to every piece, including a pallet, that exceeds the scale weight of 1501b (70 kg) or with a single dimension in excess of 48 in (120 cm). Further, DHL does not accept shipping pieces, skids or pallets with an actual weight that exceeds 6601b (300 kg) or a size that exceeds 118 in (300 cm) in length, width or height. Thus, shipping medium sized shipments may require choosing between a seagoing shipper with a moderate shipping cost and a long lead time, or by air with a shorter delivery time, e.g., overnight, in exchange for paying a premium shipping rate.

For both air and sea shipping, in addition to exposure to property loss from a potential maritime disaster, there is a potential for a loss of life. A ship that sinks at sea may suffer the loss of the entire crew. Likewise, a cargo plane typically has a pilot and copilot. A cargo plane that goes down at sea may suffer the loss of one or both of the pilot and copilot.

Accordingly, there is a need for an efficient, flexible approach to shipping, and especially for medium sized shipments, and especially, without the potential of loss of crew via autonomous or semi-autonomous multi-platform unmanned vehicles, and more particularly, unmanned Wing In Ground Effect (WIG) crafts or vessels, which require an efficient, robust and safe autonomous navigation system.

### SUMMARY

There is provided a method for providing autonomous and semi-autonomous navigation of a vehicle over water, comprising the steps of:
receiving data in the form of buoy water state data and vehicle sensor data;
computing a mean wave and water height in a path of the vehicle;
computing a mean theoretical water height from the buoy water state data and setting it as a base datum;
generating 3D curves from the received data;
converting the 3D curves into 2D planar point data,
determining wave peaks from maximum amplitude point data of the 2D planar point data;
generating 3D wave apex data from the wave peaks;
predicting wave height peaks based on current buoy water state data;
generating flight parameters using the received data, the 3D wave apex data and the predicted wave height peaks;
generating vehicle flight control commands; and
adjusting the flight control commands using a GPS flight controller and the vehicle sensor data.

There is also provided a system for providing autonomous and semi-autonomous navigation of a vehicle over water, comprising:
vehicle sensors;
a data input for receiving data in the form of buoy water state data and vehicle sensor data from the vehicle sensors;
a vehicle control output operatively connected to the a navigation control system of the vehicle;
at least one processor operatively connected to the data input, the at least one processor having an associated memory having stored therein processor executable code that when executed by the at least one processor performs the steps of:
computing a mean wave and water height in a path of the vehicle;
computing a mean theoretical water height from the buoy water state data and setting it as a base datum;
generating 3D curves from the received data;
converting the 3D curves into 2D planar point data,
determining wave peaks from maximum amplitude point data of the 2D planar point data;
generating 3D wave apex data from the wave peaks;
predicting wave height peaks based on current buoy water state data;
generating flight parameters using the received data, the 3D wave apex data and the predicted wave height peaks;
generating vehicle flight control commands;
adjusting the flight control commands using a GPS flight controller and the vehicle sensor data; and
providing the flight control commands to the vehicle control output.

There is further provided a system for providing autonomous and semi-autonomous navigation of a vehicle over water as above, further comprising a user interface operatively connected to the at least one processor.

There is also provided a method and system for providing autonomous and semi-autonomous navigation of a vehicle over water as above, wherein the buoy water state data includes local wind speed and wave height data, and/or wherein the vehicle sensor data include data provided by a front sensor, a left sensor, a right sensor, and a bottom sensor.

There is further provided a method and system for providing autonomous and semi-autonomous navigation of a vehicle over water as above, wherein the step of computing a mean wave and water height includes is performed using an average triangulation of the heights of three closest buoys in a path of the vehicle

There is also provided a method and system for providing autonomous and semi-autonomous navigation of a vehicle over water as above, wherein the 3D wave apex data is generated from an average 3-point peak dynamic floating plane from the wave peaks.

There is further provided a method and system for providing autonomous and semi-autonomous navigation of a vehicle over water as above, wherein the received data further includes satellite data, for example GPS data, and/or other sources data, for example air traffic data and/or maritime control data.

There is further provided an over water wing in ground effect vehicle having an autonomous and semi-autonomous navigation system as above.

### BRIEF DESCRIPTION OF THE FIGURES

Embodiments of the disclosure will be described by way of examples only with reference to the accompanying drawing, in which:

FIG. 1 is a schematic representation of the 4-D wave mapping navigation system and method data sources in accordance with an illustrative embodiment of the present disclosure;

FIGS. 2A, 2B and 2C are schematic representation the placement of sensors on the vehicle in accordance with the illustrative embodiment of the present disclosure;

FIG. 3 is an example of 2D planar point data;

FIG. 4 is a flow diagram of the 4-D wave mapping navigation process in accordance with the illustrative embodiment of the present disclosure; and

FIG. 5 is a schematic representation of the 4-D wave mapping navigation system in accordance with the illustrative embodiment of the present disclosure.

Similar references used in different Figures denote similar components.

### DETAILED DESCRIPTION

Generally stated, the non-limitative illustrative embodiments of the present disclosure provide a 4-D wave mapping, navigation system and method using dynamic fluid height telemetry for autonomous or semi-autonomous multi-platform unmanned or manned vehicles, and more particularly Wing In Ground Effect (WIG) crafts or vessels. It is to be understood that the 4-D wave mapping, navigation system and method may also be used with any vehicle or object, including rocket propelled objects, autonomous or semi-autonomous, which needs to maintain altitude above any dynamic fluid system. The 4-D wave mapping, navigation system and method may further be used in the maritime shipping industry, with the increase in power and range of sensors, for navigating around storm systems or open water anomalies.

There has been a market surge in the demand for time-sensitive, price-sensitive shipping along coastal regions around the world. When shipping goods over large bodies of water, companies have two options. They can either use an airplane, which is fast but can be expensive, or they can use boats which are slow, but inexpensive. There is no middle ground that balances both speed and cost. Autonomous Wing In Ground Effect (WIG) crafts or vessels will fill this gap by providing access to countless delivery points faster than boats and at a fraction of the cost of aircrafts.

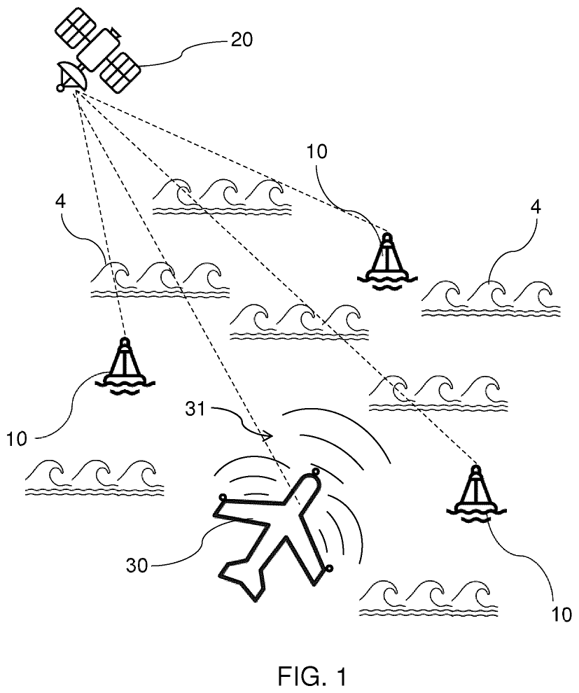

Referring to FIG. 1, the 4-D wave mapping, navigation system and method comprises an AI that analyses, in real-time, dynamic fluid height telemetry acquired from a variety of data sources, such as maritime buoys 10, which register information such as local wind speed and wave 4 height, satellite 20, which relay the buoys 10 as well as additional data such as GPS, etc., and vehicle 30 on-board sensors.

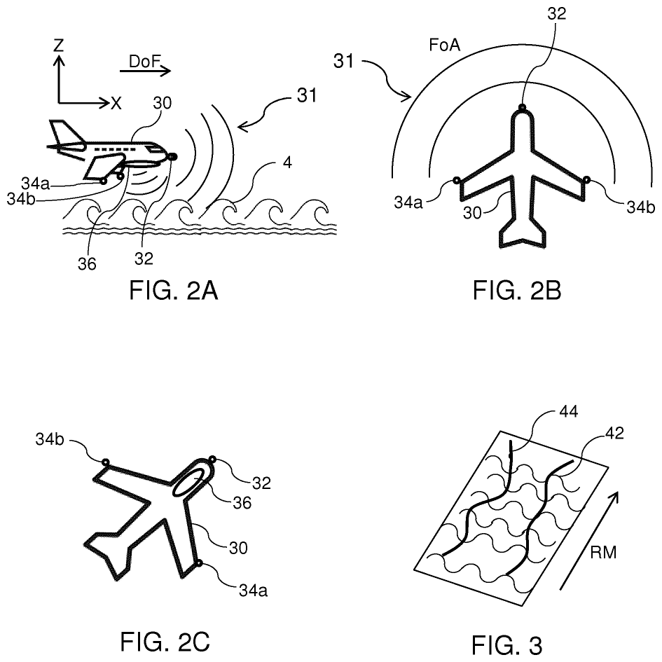

FIGS. 2A, 2B and 2C, shows the placement of the sensors on the vehicle 30 in accordance with the illustrative embodiment of the present disclosure, namely front 32, left 34a, right 34b and bottom 36 sensors, that send out a multi-directional array of signals 31 to map real-time 3D wave 4 data. There is also shown the 2-D mapping in the X-Z coordinates of the waves 4 according to the direction of flight DoF of the vehicle 30 (FIG. 2A), and the 180° field of array FoA of the multi-directional array of signals 31 (FIG. 2B).

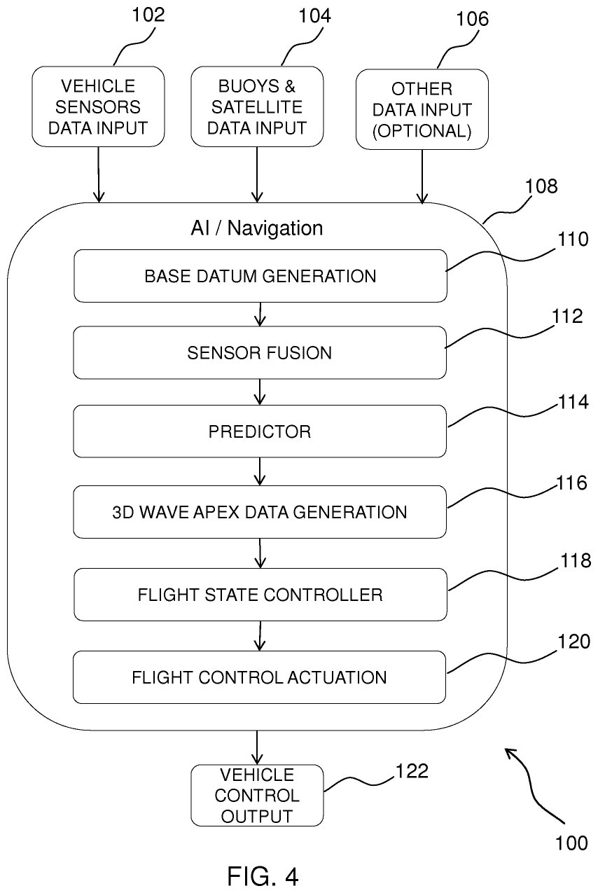

Referring now to FIG. 4, there is shown a flow diagram of the 4-D wave mapping, navigation process 100 in accordance with the illustrative embodiment of the present disclosure. Steps of the process 100 are indicated by blocks 102 to 122.

The process 100 starts by inputting maritime data, namely from vehicle 30 sensors 32, 34a, 34b, 36 at block 102, buoy system 10 and satellite 20 data at block 104, and, optionally, other sources data, such as air traffic and/or maritime control data, at block 106.

Them, at block 108, the inputted data from blocks 102, 104 and 106 is processed by the AI/navigation sub-process 108, which provides the auto pilot controller for the vehicle 30.

At block 110, the AI/navigation sub-process generates a reference base datum using the buoys 10 water state (e.g., local wind speed and wave height) data. The base datum is generated by computing a mean wave and water height, this is accomplished using the average triangulation of the heights of the three closest buoys 10 in the path of the vehicle 30. A mean theoretical water height is then generated, which acts as a base datum for the vehicle 30.

At block 112, with reference to FIG. 3, sensor data from the sensors 32, 34a, 34b, 36, buoys 10, satellite 20 and, optionally, other sources data 50, are fused to generate 3D curves, which are then, at block 114, converted into 2D planar point data with respect to the viewed reference plane define. The maximum amplitude point data of the 2D curves are determined and registered as wave peaks 42. Thus, using the wave peaks 42, along with the fused sensor data, a mean slope vector for average wave height 44 in the relative motion RM direction of the vehicle 30 is formed.

Then, at block 116, 3D wave apex data is generated in the form of an average 3-point peak dynamic floating wave plane to keep the vehicle 30 above the waves 4. This wave plane combined with the base datum from block 110 act as ground 0.00″ for the autopilot. A configurable delta height variation above ground 0.00″ is set to maintain a predetermined height delta for steady flight above water (i.e., waves 4).

At block 118, using precedence rules, the AI/navigation sub-process 108 learns to predict wave height peaks based on the current water state, which allows more predictive navigation (i.e., flight control) via auto pilot. Basic flight parameters like altitude of flight and altitude as well as navigational information such as heading, lateral and vertical course and course deviation are determined by a series of rules and the information from the previous steps.

Then, at block 120, the AI/navigation sub-process 108 converts the real-time data from block 118 into rules to make actuation decisions. It also uses a GPS flight controller with waypoints and default return to course as well as the sensors 32, 34a, 34b, 36 data to sense and avoid waves, static or moving objects to create a linear flight path, provided to the vehicle 30 at block 122, to arrive at destination in the shortest amount of time.

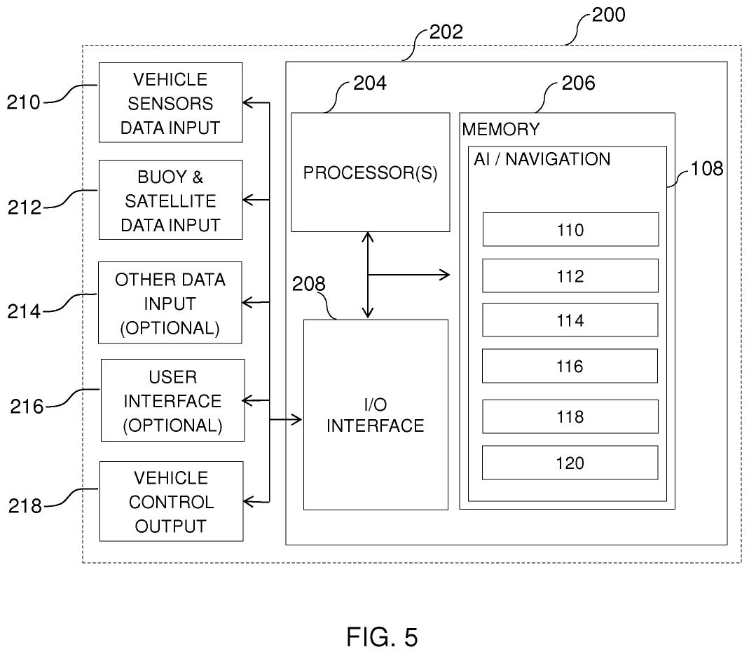

Referring now to FIG. 5, the 4-D wave mapping navigation system 200 includes a processing unit 202 having one or more processor(s) 204 with an associated memory 206 having stored therein processor executable instructions of the AI/navigation sub-process 108 for executing the base datum generation 110, sensor fusion 112, predictor 114, 3D wave apex data generation 116, flight state controller 118 and flight control actuation 120 steps. The AI/navigation sub-process 108 may be implemented, for example, using a convolutional neural network. It is to be understood that other processes, libraries and tools' executable instructions may be stored in the memory 206 in order to support the AI/navigation sub-process 108.

The processing unit 202 further includes an input/output (I/O) interface 208 for communication with the vehicle sensors data input 210, buoy and satellite data input 212, optional other data input 214, optional user interface 216 and vehicle control output 218. The optional user interface 216 may include, for example, any one or combination of a touch screen, keyboard, mouse, trackpad, joystick, gesture interface, scanner, etc., in order to operate the 4-D wave mapping navigation system 200 and/or the vehicle 30.

Although the present disclosure has been described with a certain degree of particularity and by way of an illustrative embodiments and examples thereof, it is to be understood that the present disclosure is not limited to the features of the embodiments described and illustrated herein, but includes all variations and modifications within the scope of the disclosure.

1. A method for providing autonomous and semi-autonomous navigation of a vehicle over water, comprising the steps of:
receiving data in the form of buoy water state data and vehicle sensor data;
computing a mean wave and water height in a path of the vehicle;
computing a mean theoretical water height from the buoy water state data and setting it as a base datum;
generating 3D curves from the received data;
converting the 3D curves into 2D planar point data,
determining wave peaks from maximum amplitude point data of the 2D planar point data;
generating 3D wave apex data from the wave peaks;
predicting wave height peaks based on current buoy water state data;
generating flight parameters using the received data, the 3D wave apex data and the predicted wave height peaks;
generating vehicle flight control commands; and
adjusting the flight control commands using a GPS flight controller and the vehicle sensor data.

2. A method according to claim 1, wherein the buoy water state data includes local wind speed and wave height data.

3. A method according to claim 1, wherein the vehicle sensor data include data provided by a front sensor, a left sensor, a right sensor, and a bottom sensor.

4. A method according to claim 1, wherein the step of computing a mean wave and water height includes is performed using an average triangulation of the heights of three closest buoys in a path of the vehicle.

5. A method according to claim 1, wherein the 3D wave apex data is generated from an average 3-point peak dynamic floating plane from the wave peaks.

6. A method according to claim 1, wherein the received data further includes satellite data.

7. A method according to claim 6, wherein the satellite data includes GPS data.

8. A method according to claim 1, wherein the received data further includes other sources data.

9. A method according to claim 8, wherein the other sources data includes at least one of air traffic data and maritime control data.

10. A system for providing autonomous and semi-autonomous navigation of a vehicle over water, comprising:
vehicle sensors;
a data input for receiving data in the form of buoy water state data and vehicle sensor data from the vehicle sensors;
a vehicle control output operatively connected to the a navigation control system of the vehicle;
at least one processor operatively connected to the data input, the at least one processor having an associated memory having stored therein processor executable code that when executed by the at least one processor performs the steps of:
computing a mean wave and water height in a path of the vehicle;
computing a mean theoretical water height from the buoy water state data and setting it as a base datum;
generating 3D curves from the received data;
converting the 3D curves into 2D planar point data,
determining wave peaks from maximum amplitude point data of the 2D planar point data;
generating 3D wave apex data from the wave peaks;
predicting wave height peaks based on current buoy water state data;
generating flight parameters using the received data, the 3D wave apex data and the predicted wave height peaks;
generating vehicle flight control commands;
adjusting the flight control commands using a GPS flight controller and the vehicle sensor data; and
providing the flight control commands to the vehicle control output.

11. A system according to claim 10, further comprising a user interface operatively connected to the at least one processor.

12. A system according claim 10, wherein the buoy water state data includes local wind speed and wave height data.

13. A system according to claim 10, wherein the vehicle sensor data include data provided by a front sensor, a left sensor, a right sensor, and a bottom sensor.

14. A system according to claim 10, wherein the step of computing a mean wave and water height includes is performed using an average triangulation of the heights of three closest buoys in a path of the vehicle.

15. A system according to claim 10, wherein the 3D wave apex data is generated from an average 3-point peak dynamic floating plane from the wave peaks.

16. A system according to claim 10, wherein the received data further includes satellite data.

17. A system according to claim 16, wherein the satellite data includes GPS data.

18. A system according to claim 10, wherein the received data further includes other sources data.

19. A system according to claim 18, wherein the other sources data includes at least one of air traffic data and maritime control data.

20. An over water wing in ground effect vehicle having an autonomous and semi-autonomous navigation system in accordance with claim 10.
